(19) United States
(12) Patent Application Publication
(10) Pub. No.: US 2023/0291224 A1
(43) Pub. Date: Sep. 14, 2023

(54) CHARGE CONTROLLER AND VEHICLE

(71) Applicant: TOYOTA JIDOSHA KABUSHIKI KAISHA, Toyota-shi Aichi-ken (JP)

(72) Inventor: Takahiro Misawa, Toyota-shi Aichi-ken (JP)

(73) Assignee: TOYOTA JIDOSHA KABUSHIKI KAISHA, Toyota-shi Aichi-ken (JP)

(21) Appl. No.: 18/105,034

(22) Filed: Feb. 2, 2023

(30) Foreign Application Priority Data
Mar. 14, 2022 (JP) 2022-039035

(51) Int. Cl. H02J 7/00; B60L 53/66; B60L 53/20; B60L 53/62

(52) U.S. Cl. CPC H02J 7/007192; B60L 53/66; B60L 53/20; B60L 53/62; B60L 2240/525

(57) ABSTRACT

An ECU controls external charging for charging a battery of a vehicle with electric power from an electric power station. A step-up converter steps up an input voltage that is a voltage of electric power input to the step-up converter through an inlet from the electric power station and outputs a step-up voltage that is the stepped-up voltage to the battery. The step-up converter is configured to charge the battery. A processor of the ECU is configured to execute drive control over the step-up converter. The processor is configured to set a step-up ratio that is a ratio between the input voltage and the step-up voltage in accordance with a temperature of the step-up converter.

### CROSS-REFERENCE TO RELATED APPLICATION

This application claims priority to Japanese Patent Application No. 2022-039035 filed on Mar. 14, 2022, incorporated herein by reference in its entirety.

### BACKGROUND

### 1. Technical Field

The disclosure relates to a charge controller and a vehicle.

### 2. Description of Related Art

Japanese Unexamined Patent Application Publication No. 2009-194986 (JP 2009-194986 A) describes a vehicle on which an electrical storage device, a controller, and a step-up converter are mounted. The electrical storage device is configured to be chargeable. The controller controls the step-up converter. The step-up converter steps up an input voltage and outputs the stepped-up voltage.

### SUMMARY

A vehicle can be configured to be able to perform external charging for charging an electrical storage device of the vehicle with electric power supplied through a power receiving unit from a power installation outside the vehicle. A controller of the thus configured vehicle is configured to control external charging. When a step-up device is provided between the power receiving unit and the electrical storage device, the step-up device is configured to charge the electrical storage device by stepping up the voltage of electric power received by the power receiving unit and outputting the stepped-up voltage (step-up voltage) to the electrical storage device. On the other hand, the thus configured step-up device can overheat by heat generated during operation.

The disclosure, in a charge controller that controls external charging of a vehicle equipped with a step-up device that steps up the voltage of electric power from a power installation and charges an electrical storage device, protects the step-up device from overheating.

The disclosure, in a vehicle equipped with a step-up device that steps up the voltage of electric power from a power installation and charges an electrical storage device, protects the step-up device from overheating.

An aspect of the disclosure provides a charge controller. The charge controller controls external charging for charging an electrical storage device of a vehicle with electric power from a power installation outside the vehicle. The vehicle includes a power receiving unit and a step-up device. The power receiving unit is configured to receive electric power from the power installation. The step-up device is provided between the power receiving unit and the electrical storage device. The step-up device is configured to step up an input voltage that is a voltage of electric power input to the step-up device through the power receiving unit from the power installation and output a step-up voltage that is the stepped-up voltage to the electrical storage device. The step-up device is configured to charge the electrical storage device by supplying output electric power that is electric power at the step-up voltage to the electrical storage device. The charge controller includes an electronic control unit including a memory. The electronic control unit is configured to execute drive control over the step-up device. The electronic control unit is configured to set a step-up ratio that is a ratio between the input voltage and the step-up voltage in accordance with a temperature of the step-up device.

With the above configuration, the temperature of the step-up device is reflected in the step-up ratio. Thus, it is possible to set the step-up ratio such that the temperature of the step-up device does not excessively increase. As a result, it is possible to protect the step-up device from overheating.

The electronic control unit may be configured to execute a loss reduction process of setting the step-up ratio such that a power loss in the step-up device is reduced when the temperature of the step-up device is high as compared to when the temperature of the step-up device is low.

With the above configuration, the amount of heat generation due to a power loss in the step-up device reduces when the temperature of the step-up device is high as compared to when the temperature of the step-up device is low. Thus, it is possible to suppress a further increase in the temperature of the step-up device.

In the loss reduction process, the electronic control unit may be configured to set the step-up ratio such that the power loss is reduced when the temperature of the step-up device is higher than or equal to a threshold temperature as compared to when the temperature of the step-up device is lower than the threshold temperature.

With the above configuration, it is possible to set the step-up ratio regardless of a reduction in power loss until the temperature of the step-up device becomes the threshold temperature. Thus, it is possible to set the step-up ratio without limiting the step-up ratio to reduce the power loss.

The electronic control unit may be configured to send, to the power installation, a command value of current supplied from the power installation to the power receiving unit. Then, the electronic control unit may be configured to reduce the command value when the temperature of the step-up device is higher than or equal to the threshold temperature after executing the loss reduction process.

With the above configuration, when the temperature of the step-up device does not decrease to below the threshold temperature after the loss reduction process, current input to the step-up device through the power receiving unit from the power installation reduces. Thus, electric power input to the step-up device reduces. As a result, it is possible to further reduce the amount of heat generation due to a power loss in the step-up device. Therefore, it is possible to further effectively suppress an increase in the temperature of the step-up device.

In the loss reduction process, the electronic control unit may be configured to set the step-up ratio such that the power loss is reduced as the temperature of the step-up device increases.

With the above configuration, the power loss is reduced as the temperature of the step-up device increases. Thus, as the temperature of the step-up device increases, heat generation in the step-up device is more suppressed. As a result, it is possible to further effectively suppress an increase in the temperature of the step-up device.

The electronic control unit may be configured to execute an output power increasing process of setting the step-up ratio such that the output electric power increases when the temperature of the step-up device is low as compared to when the temperature of the step-up device is high.

As the output electric power of the step-up device increases, electric power supplied to the electrical storage device increases. With the above configuration, electric power supplied to the electrical storage device increases when the temperature of the step-up device is low as compared to when the temperature of the step-up device is high. Thus, it is possible to improve the rate of charge of the electrical storage device during external charging.

In the output power increasing process, the electronic control unit may be configured to maximize the output electric power within a range of electric power that the step-up device is allowed to output to the electrical storage device.

With the above configuration, electric power supplied to the electrical storage device increases as much as possible. Thus, it is possible to improve the rate of charge of the electrical storage device during external charging as much as possible.

When a user operation has been performed to equalize the step-up ratio in a case where the temperature of the step-up device is low with the step-up ratio in a case where the temperature of the step-up device is high and the loss reduction process is executed, the electronic control unit may be configured to set the step-up ratio in accordance with a result of the user operation without executing the output power increasing process.

With the above configuration, even when the temperature of the step-up device is low, the step-up ratio is set as in the case where the loss reduction process is executed without executing the output power increasing process. Thus, it is possible to reduce the power loss even when the temperature of the step-up device is low. In addition, a user's intention is reflected in the amount of power loss in the step-up device. As a result, it is possible to improve the convenience of a user.

The step-up device may include a first element connected to a positive electrode of the electrical storage device. The electronic control unit may be configured to increase the step-up ratio when a temperature of the first element, that is, the temperature of the step-up device, exceeds a first reference temperature.

As the step-up ratio is increased, current flowing through the first element reduces. With the above configuration, when the temperature of the first element exceeds the first reference temperature, current flowing through the first element reduces. Thus, the amount of heat generation due to a power loss in the first element reduces. As a result, it is possible to protect the first element of the step-up device from overheating.

The step-up device may include a second element connected to a negative electrode of the electrical storage device. The electronic control unit may be configured to reduce the step-up ratio when a temperature of the second element, that is, the temperature of the step-up device, exceeds a second reference temperature.

As the step-up ratio is reduced, current flowing through the second element reduces. With the above configuration, when the temperature of the second element exceeds the second reference temperature, current flowing through the second element reduces. Thus, the amount of heat generation due to a power loss in the second element reduces. As a result, it is possible to protect the second element of the step-up device from overheating.

Another aspect of the disclosure provides a vehicle including the above-described charge controller.

According to the aspects of the disclosure, it is possible to protect the step-up device, which steps up the voltage of electric power from the power installation and charges the electrical storage device, from overheating.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that schematically shows a charging system according to a first embodiment;

FIG. 2 is a diagram that shows the configuration of a vehicle in details;

FIG. 3 is a diagram that shows the configuration of a step-up converter in details;

FIG. 4 is a graph for illustrating an example of a method of setting a step-up ratio by an ECU according to the first embodiment;

FIG. 5 is a graph for illustrating another example of a method of setting a step-up ratio by the ECU;

FIG. 6 is a diagram that shows an example of a map stored in a memory of the ECU;

FIG. 7 is a flowchart that shows an example of a process that is executed by the ECU according to the first embodiment;

FIG. 8 is a flowchart that shows an example of a process that is executed by the ECU according to a first modification of the first embodiment;

FIG. 9 is a flowchart that shows an example of a process that is executed by the ECU according to a second modification of the first embodiment; and

FIG. 10 is a flowchart that shows an example of a process that is executed by the ECU according to a third modification of the first embodiment.

### DETAILED DESCRIPTION OF EMBODIMENTS

Hereinafter, embodiments of the disclosure will be described in detail with reference to the accompanying drawings. Like reference signs denote the same or corresponding portions in the drawings, and the description thereof will not be repeated.

### First Embodiment

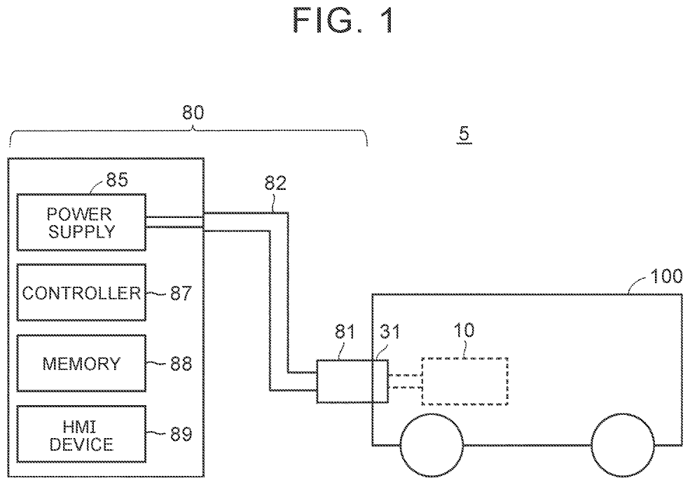

FIG. 1 is a diagram that schematically shows a charging system 5 according to a first embodiment. As shown in FIG. 1, the charging system 5 includes a vehicle 100 and an electric power station 80. The vehicle 100 is configured to be able to perform external charging for charging a battery 10 (described later) by using the electric power station 80 outside the vehicle 100.

In the first embodiment, the vehicle 100 is a battery electric vehicle (BEV). The vehicle 100 may be, for example, an electrified vehicle, such as a hybrid vehicle (HV) further equipped with an internal combustion engine (not shown) and a fuel cell vehicle (FCV).

The vehicle 100 includes a battery 10 and an inlet 31. The battery 10 is a secondary battery, such as a lithium ion battery and a nickel-metal hydride battery. The battery 10 may be replaced with an electrical storage device, such as an electrical double-layer capacitor. The battery 10 is a high-voltage battery (for example, 800 V) for storing drive electric power.

The inlet 31 is configured to receive electric power from the electric power station 80. The inlet 31 is configured to connect with a connector 81 of the electric power station 80.

The electric power station 80 is a power installation (charging facility) allowed to perform boosting charge of the vehicle 100 by supplying the vehicle 100 with direct-current power at a voltage of, for example, 400 V.

The electric power station 80 includes a power cable 82, a connector 81, a power supply 85, an HMI device 89, a memory 88, and a controller 87.

The power cable 82 includes power lines and signal lines (both are not shown). When the connector 81 is connected to the inlet 31, the electric power station 80 is connected to the vehicle 100 through the power lines and the signal lines. Thus, for example, a controller area network (CAN) communication, a power line communication (PLC), or both communications can be established between the electric power station 80 and the vehicle 100.

The power supply 85 is configured to supply electric power to the vehicle 100 through the power cable 82 and the connector 81. Thus, electric power from the electric power station 80 is supplied to the battery 10 through the inlet 31 (external charging of the vehicle 100 is performed).

The HMI device 89 receives user operation input to provide instructions on the mode of operation of the electric power station 80. A user operation is performed to, for example, provide instructions to start or stop supply of electric power from the electric power station 80 to the vehicle 100. A user operation may be performed to set a voltage or current output from the electric power station 80 to the inlet 31 of the vehicle 100.

The memory 88 stores a program and data used by the controller 87. The memory 88 further stores information indicating the ranges of voltage and current allowed to be output from the electric power station 80 to the inlet 31 of the vehicle 100.

The controller 87 controls the electric power supplied from the electric power station 80 to the vehicle 100 by running the program stored in the memory 88.

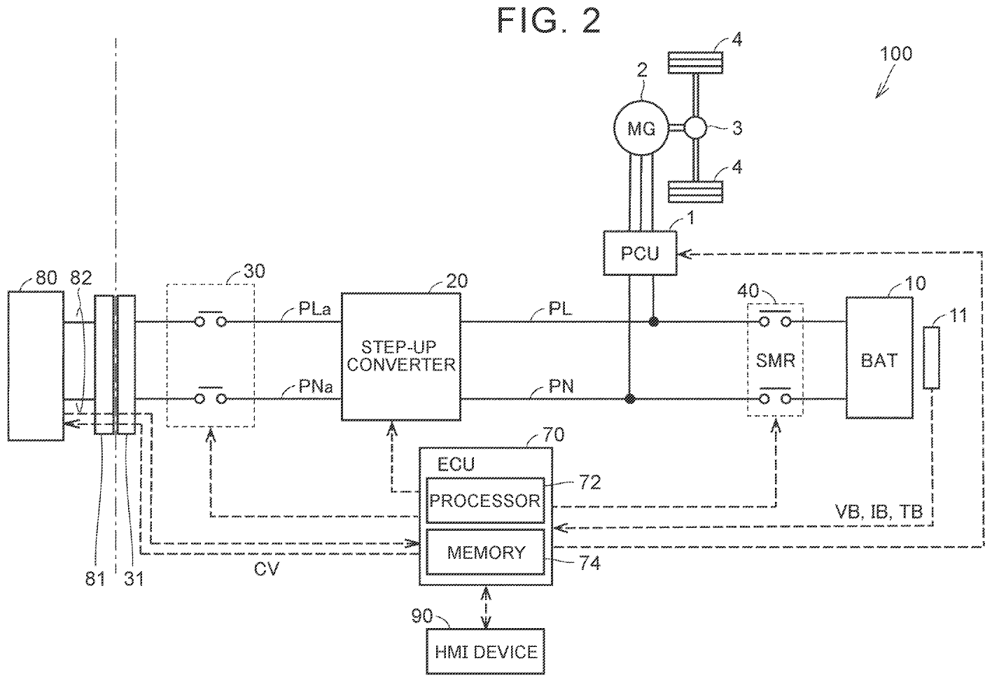

FIG. 2 is a diagram that shows the configuration of the vehicle 100 in details. As shown in FIG. 2, the vehicle 100 includes a power control unit (PCU) 1, a motor generator (MG) 2, a power transmission gear 3, and drive wheels 4 in addition to the battery 10 and the inlet 31. The vehicle 100 further includes a step-up converter 20, a monitoring unit 11, a system main relay (SMR) 40, a charging relay 30, an HMI device 90, and an electronic control unit (ECU) 70.

The PCU 1 is a power conversion device that bidirectionally converts electric power between the MG 2 and the battery 10.

The MG 2 is shown as an example of a rotating electrical machine that is driven by the PCU 1 and is, for example, an embedded permanent magnet synchronous motor. The output torque of the MG 2 is transmitted to the drive wheels 4 via the power transmission gear 3. Thus, the vehicle 100 runs.

The step-up converter 20 is provided between the inlet 31 and the battery 10. In this example, the step-up converter 20 is a non-isolated DC-DC converter. The step-up converter 20 receives electric power input from the electric power station 80 through the inlet 31 and a positive electrode line PLa and a negative electrode line PNa. The step-up converter 20 steps up an input voltage that is the voltage of electric power input. The step-up converter 20 outputs a step-up voltage that is the stepped-up voltage to a positive electrode line PL and a negative electrode line PN. The step-up converter 20 is configured to charge the battery 10 by supplying the battery 10 with output electric power that is the electric power at the step-up voltage. The range of the input voltage allowed to be input to the step-up converter 20 (also referred to as inputtable voltage) is determined in advance in accordance with the specifications of the step-up converter 20. The configuration of the step-up converter 20 will be described in detail later.

The monitoring unit 11 includes a voltage sensor, a current sensor, and a temperature sensor (all are not shown). The voltage sensor detects a voltage VB that is the voltage between the terminals of the battery 10. The current sensor detects a current IB that is the input and output current of the battery 10. The temperature sensor detects the temperature TB of the battery 10. The sensors of the monitoring unit 11 output the detection results to the ECU 70.

The SMR 40 is electrically connected to the positive electrode line PL and the negative electrode line PN. The positive electrode line PL is configured to connect the step-up converter 20 and the PCU 1 to the positive electrode of the battery 10. The negative electrode line PN is configured to connect the step-up converter 20 and the PCU 1 to the negative electrode of the battery 10. When the SMR 40 is closed (ON) (that is, a continuous state), the battery 10 can be charged with electric power at the step-up voltage. On the other hand, when the SMR 40 is open (OFF) (that is, an interrupted state), electrical connection between the battery 10 and the step-up converter 20 is interrupted, so the battery 10 is not charged.

The charging relay 30 is provided between the inlet 31 and the step-up converter 20 and is electrically connected to the positive electrode line PLa and the negative electrode line PNa. The charging relay 30 is configured to switch electrical connection between the electric power station 80 and the step-up converter 20. When the charging relay 30 is in an open state (OFF), electrical connection between the electric power station 80 and the step-up converter 20 is interrupted. On the other hand, when the charging relay 30 is in a closed state (ON), the step-up converter 20 is electrically connected to the electric power station 80. Thus, electric power from the electric power station 80 can be input to the step-up converter 20.

The HMI device 90 is a touch screen capable of receiving various operations input from a user. The HMI device 90 is capable of receiving, for example, the input setting of an operating mode (described later) of the step-up converter 20 during external charging.

The ECU 70 includes a memory 74 and a processor 72. The memory 74 includes a read only memory (ROM) and a random access memory (RAM). The ROM stores a program and data used by the processor 72. The RAM functions as a working memory. The memory 74 stores, for example, information indicating the range of the inputtable voltage of the step-up converter 20. An example of data stored in the memory 74 will be described in detail later.

The processor 72 executes various processes by running the program stored in the memory 74. The processor 72 includes a processor, such as a central processing unit (CPU). The processor 72 executes, for example, drive control over the step-up converter 20.

The ECU 70 controls devices of the vehicle 100, that is, the PCU 1, the MG 2, the step-up converter 20, the charging relay 30, the SMR 40, the HMI device 90, and the like, in accordance with a signal received from the monitoring unit 11, signals received from various sensors (not shown), and the program stored in the memory 74.

The ECU 70 calculates, for example, the SOC of the battery 10 in accordance with the detected values of the voltage VB, current IB, and temperature TB from the monitoring unit 11. The ECU 70 is configured to communicate with the electric power station 80 through the power cable 82 (by, for example, CAN communication).

The ECU 70 is configured to execute external charging control for controlling external charging of the vehicle 100. When instructions to start external charging of the vehicle 100 are provided with the use of the HMI device 89 of the electric power station 80, a signal indicating the instructions is sent from the electric power station 80 to the vehicle 100 through the power cable 82. The ECU 70 outputs, to the electric power station 80, a request to start supplying electric power to the vehicle 100 in response to reception of the signal and controls the charging relay 30 and the SMR 40 to a closed state. Thus, external charging of the vehicle 100 is started. After that, when the SOC of the battery 10 increases to a predetermined threshold SOC, the ECU 70 stops external charging of the vehicle 100 by outputting a request to stop supplying electric power to the electric power station 80. The threshold SOC is, for example, an SOC at the time when the battery 10 is fully charged. The ECU 70 is also configured to send, to the electric power station 80, a command value CV of current supplied from the electric power station 80 to the inlet 31 through, for example, CAN communication.

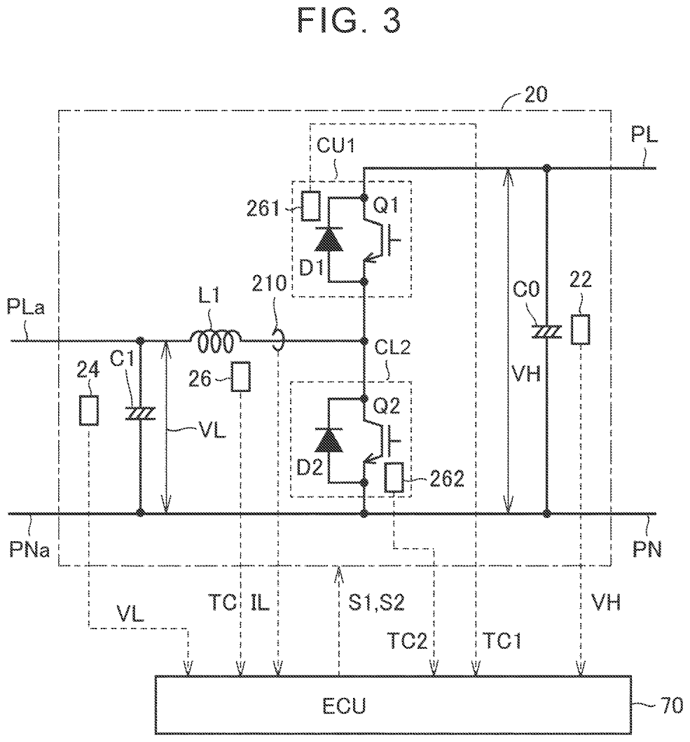

FIG. 3 is a diagram that shows the configuration of the step-up converter 20 in details. As shown in FIG. 3, the step-up converter 20 is a step-up copper circuit and includes a capacitor C1 and an input voltage sensor 24. The step-up converter 20 further includes a reactor L1, a reactor current sensor 210, an upper arm circuit CU1, a lower arm circuit CL2, and a temperature sensor 26. The step-up converter 20 further includes a capacitor C0 and a step-up voltage sensor 22.

The capacitor C1 is connected between the positive electrode line PLa and the negative electrode line NLa. The capacitor C1 smooths the alternating-current component of voltage fluctuations between the positive electrode line PLa and the negative electrode line NLa.

The input voltage sensor 24 detects the voltage between both ends of the capacitor C1 (the input voltage VL of the step-up converter 20) and outputs the detected value to the ECU 70.

The reactor L1 is connected to the positive electrode line PLa and is electrically connected to a middle point (connection node) between a switching element Q1 and a switching element Q2.

The reactor current sensor 210 detects a current flowing through the reactor L1 (also referred to as reactor current IL) and outputs the detected value to the ECU 70.

The upper arm circuit CU1 is connected to the positive electrode of the battery 10 through the positive electrode line PL. The upper arm circuit CU1 includes the switching element Q1, a diode D1, and a temperature sensor 261.

The lower arm circuit CL2 is connected to the negative electrode of the battery 10 through the negative electrode line NL. The lower arm circuit CL2 includes the switching element Q2, a diode D2, and a temperature sensor 262.

The switching elements Q1, Q2 are connected in series between the positive electrode line PL and the negative electrode line PN. The switching elements Q1, Q2 are configured to complementarily and alternately perform switching operation (on/off operation) basically within respective switching periods in accordance with signals S1, S2 output from the ECU 70. The switching elements Q1, Q2 each are, for example, an insulated gate bipolar transistor (IGBT), a metal oxide semiconductor (MOS) transistor, or a bipolar transistor. The diodes D1, D2 are respectively connected in antiparallel with the switching elements Q1, Q2.

The temperature sensor 261 detects the temperature TC1 of the upper arm circuit CU1 (in this example, the diode D1). The temperature sensor 262 detects the temperature TC2 of the lower arm circuit CL2 (in this example, the switching element Q2). The detected values of the temperature sensors 261, 262 are output to the ECU 70.

The temperature sensor 26 detects the temperature TC of the step-up converter 20 and outputs the detected value to the ECU 70. The temperature sensor 26 may be disposed so as to detect the temperature of the reactor L1 or may be disposed so as to detect the temperature of the switching element Q1 or switching element Q2.

The capacitor C0 is connected between the positive electrode line PL and the negative electrode line NL. The capacitor C0 smooths the voltage between the positive electrode line PL and the negative electrode line NL. The voltage between both ends of the capacitor C0 corresponds to the step-up voltage VH of the step-up converter 20. The step-up voltage sensor 22 detects the step-up voltage VH and outputs the detected value to the ECU 70.

The step-up operation of the step-up converter 20 is performed by supplying electromagnetic energy accumulated in the reactor L1 during an on duration of the switching element Q2 to the positive electrode line PL via the switching element Q1 and the diode D1. A step-up ratio (power conversion ratio) in step-up operation is expressed by the ratio (VH/VL) of the step-up voltage VH to the input voltage VL. A step-up ratio is determined by the ratio of the on duration of each of the switching elements Q1, Q2 to a switching period (duty ratio). The duty ratio of each of the switching elements Q1, Q2 is set by the ECU 70 by using the signals S1, S2.

To achieve the high power of the battery 10, it can be requested to increase the voltage of the battery 10 above the voltage before. In this case, it is requested to further increase the step-up voltage VH during external charging of the vehicle 100. The step-up converter 20 can overheat in operation (for example, as the step-up voltage VH increases).

The ECU 70 according to the first embodiment includes components to take measures against the above-described inconvenience. The ECU 70 (more specifically, the processor 72) is configured to set the step-up ratio that is the ratio between the input voltage VL and the step-up voltage VH in accordance with the temperature of the step-up converter 20.

With the above configuration, the temperature of the step-up converter 20 is reflected in the step-up ratio. Thus, it is possible to set the step-up ratio such that the temperature of the step-up device does not excessively increase. As a result, it is possible to protect the step-up device from overheating.

In this example, the ECU 70 is configured to execute a loss reduction process of setting the step-up ratio such that a power loss in the step-up converter 20 is reduced when the temperature TC of the step-up converter 20 is high as compared to when the temperature TC of the step-up converter 20 is low. The ECU 70 sets the step-up ratio in accordance with, for example, the voltage output from the electric power station 80 to the inlet 31 and the voltage VB of the battery 10.

With the above configuration, the amount of heat generation due to a power loss in the step-up converter 20 reduces when the temperature TC is high as compared to when the temperature TC is low. Thus, it is possible to suppress a further increase in the temperature TC. As a result, it is possible to protect the step-up converter 20 from overheating. Hereinafter, control that is executed by the ECU 70 will be described in detail.

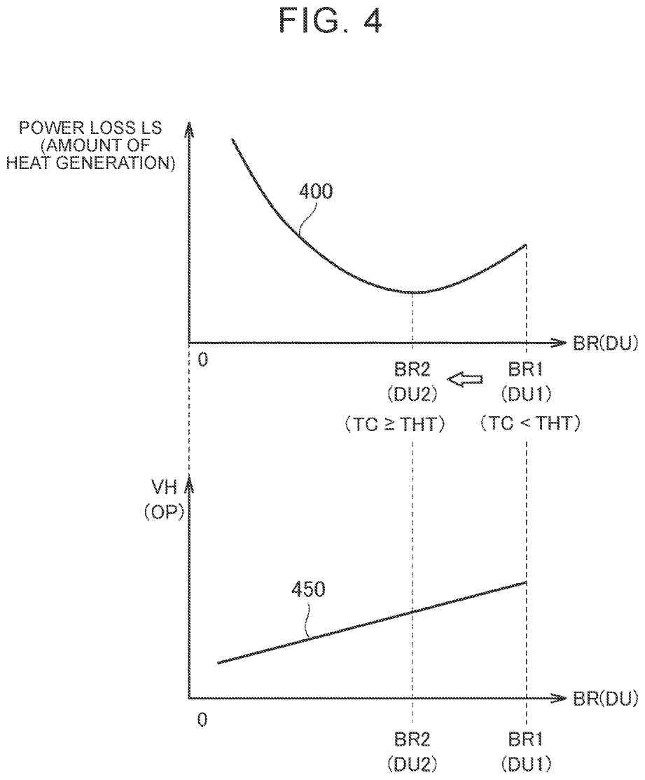

FIG. 4 is a graph for illustrating an example of a method of setting the step-up ratio by the ECU 70 according to the first embodiment. As shown in FIG. 4, the step-up ratio BR of the step-up converter 20 is set within the range of greater than zero and less than or equal to a step-up ratio BR1 (0<BR≤BR1). The step-up ratio BR1 is a maximum step-up ratio determined in advance in accordance with the specifications of the step-up converter 20. When the step-up ratio BR is the step-up ratio BR1, the duty ratio DU of each of the switching elements Q1, Q2 is a duty ratio DU1.

The curve 400 shows an example of the relationship between a power loss LS (the amount of heat generation per unit time) in the step-up converter 20, and a step-up ratio BR. The curve 400 shows that the power loss LS is minimized when the step-up ratio BR is a step-up ratio BR2 (<BR1). The duty ratio DU in the case where the step-up ratio BR is a step-up ratio BR2 is a duty ratio DU2.

The line 450 shows an example of the relationship between the step-up voltage VH and the step-up ratio BR of the step-up converter 20. The line 450 shows that the step-up voltage VH increases as the step-up ratio BR increases. As the step-up voltage VH increases, electric power supplied from the step-up converter 20 to the battery 10 (output electric power OP from the step-up converter 20 to the battery 10) increases. Therefore, the rate of charge of the battery 10 improves.

The ECU 70 executes an output power increasing process of setting the step-up ratio BR such that the output electric power OP increases when the temperature TC is low as compared to when the temperature TC is high. Thus, it is possible to improve the rate of charge of the battery 10 during external charging.

In this example, the ECU 70 maximize the output electric power OP within the range of electric power that the step-up converter 20 is allowed to output to the battery 10 (specifically, set the step-up ratio BR to the step-up ratio BR1 that is a maximum value) when the temperature TC is lower than a threshold temperature THT. Thus, electric power supplied to the battery 10 increases as much as possible. As a result, it is possible to improve the rate of charge of the battery 10 during external charging as much as possible. The threshold temperature THT is appropriately determined in advance by an experiment as a temperature for protecting the step-up converter 20 from overheating and is stored in the memory 74 of the ECU 70.

When the temperature TC is higher than or equal to the threshold temperature THT, the ECU 70 sets the step-up ratio BR such that the power loss LS is reduced as compared to when the temperature TC is lower than the threshold temperature THT (for example, changes the step-up ratio BR from the step-up ratio BR1 to the step-up ratio BR2). When the step-up ratio BR is set in this way, the ECU 70 is able to set the step-up ratio BR regardless of a reduction in power loss LS during a period until the temperature TC becomes the threshold temperature THT. During the period, the ECU 70 is able to, for example, set the step-up ratio BR (to, for example, the step-up ratio BR1) without limiting the step-up ratio BR (to, for example, the step-up ratio BR2) in order to reduce the power loss LS. Then, when the temperature TC reaches the threshold temperature THT, the ECU 70 sets the step-up ratio BR (to, for example, the step-up ratio BR2) such that the power loss LS is reduced.

FIG. 5 is a graph for illustrating another example of a method of setting a step-up ratio by the ECU 70. As shown in FIG. 5, the line 500 represents an example in which the step-up ratio BR is set to the step-up ratio BR1 when the temperature TC is lower than the threshold temperature THT and the step-up ratio BR is set to the step-up ratio BR2 when the temperature TC is higher than or equal to the threshold temperature THT. This example is the same as the example described with reference to FIG. 4.

The line 550 represents an example in which the ECU 70 sets the step-up ratio BR such that the power loss LS is reduced as the temperature TC increases. In this example, the ECU 70 gradually reduces the step-up ratio BR from the step-up ratio BR1 to the step-up ratio BR2 as the temperature TC increases (the direction indicated by the hollow arrow in FIG. 4). Thus, heat generation due to a power loss in the step-up converter 20 is more suppressed as the temperature TC increases. As a result, it is possible to effectively suppress an increase in the temperature TC as compared to the case of the line 500.

As will be described below, the step-up ratio BR may be determined in accordance with not only the temperature TC of the step-up converter 20 but also the input voltage VL and the voltage VB of the battery 10.

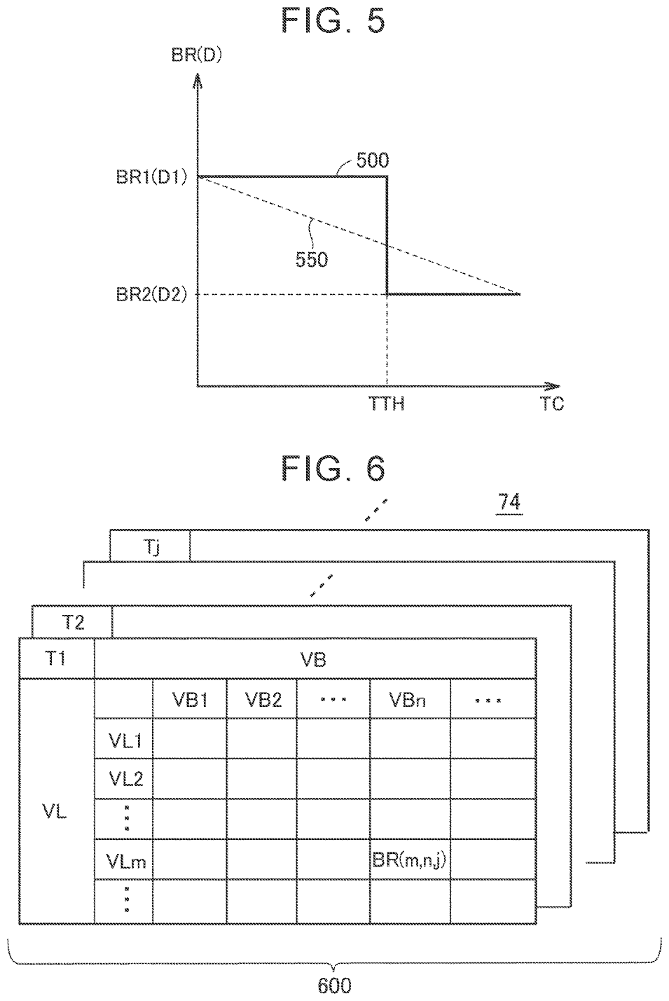

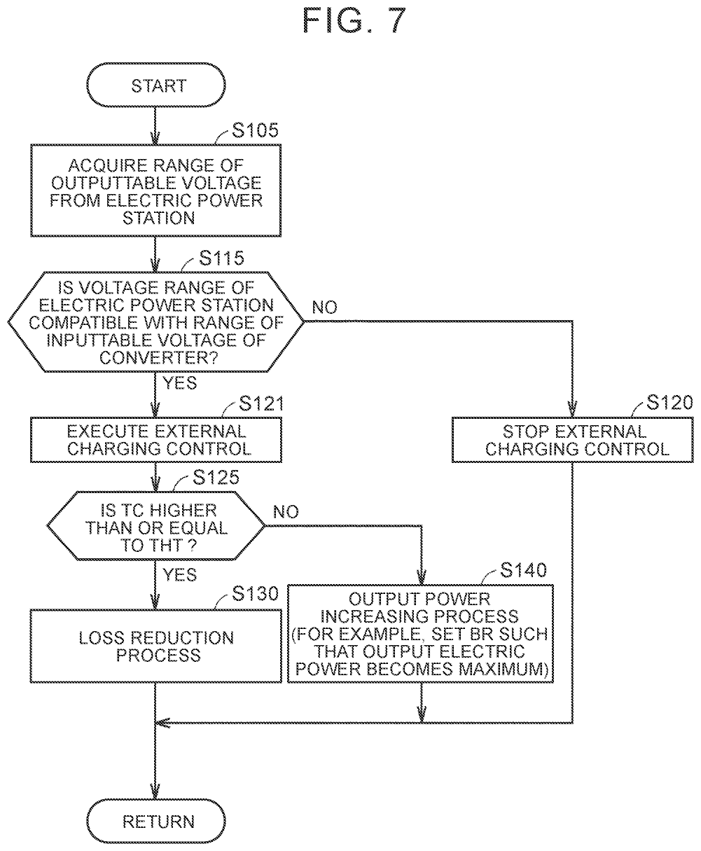

FIG. 6 is a diagram that shows an example of a map stored in the memory 74 of the ECU 70. As shown in FIG. 6, a map 600 is stored in the memory 74. The map 600 is a four-dimensional map for determining the step-up ratio BR in accordance with the temperature TC of the step-up converter 20, the input voltage VL, and the voltage VB of the battery 10.

Specifically, for the temperature TC, temperature regions (indicated by T1, T2, . . . ) divided by a predetermined width are set. For the input voltage VL, voltage regions (indicated by VL1, VL2, . . . ) divided by a predetermined width are set. For the voltage VB of the battery 10, voltage regions (indicated by VB1, VB2, . . . ) divided by a predetermined width are set.

The step-up ratio BR is determined for each combination of the divided temperature region and the divided voltage region. In this example, a step-up ratio BR(m,n,j) is shown as a step-up ratio BR associated with the temperature region Tj, the voltage region VLm, and the voltage region VBn. A step-up ratio BR(m,n,j) is appropriately determined in advance by an experiment so as to be maximized within the range in which the step-up voltage VH (=VL x BR(m,n,j)) is greater than or equal to the voltage VB of the battery 10 and the temperature TC does not increase excessively (for example, higher than or equal to the threshold temperature THT). A step-up ratio BR may be determined for each combination of the values of the temperature TC, input voltage VL, and voltage VB instead of a combination of the temperature region and the voltage region.

FIG. 7 is a flowchart that shows an example of a process that is executed by the ECU 70 (more specifically, the processor 72) according to the first embodiment. The process of the flowchart is started when instructions to start supplying electric power from the electric power station 80 to the vehicle 100 are provided with the use of the HMI device 89 of the electric power station 80 in a state where the connector 81 of the electric power station 80 is connected to the inlet 31.

As shown in FIG. 7, the ECU 70 acquires the range of voltage allowed to be output from the electric power station 80 to the inlet 31 (step S105). The ECU 70, for example, acquires the range by outputting a request to the electric power station 80 through CAN communication or PLC communication such that information indicating the range is transmitted from the electric power station 80 to the vehicle 100.

Subsequently, the ECU 70 determines whether the voltage range of the electric power station 80 is compatible with the range of inputtable voltage of the step-up converter 20 (step S115). Specifically, the ECU 70 determines whether at least part of the voltage range of the electric power station 80 falls within the range of inputtable voltage of the step-up converter 20.

When the voltage range of the electric power station 80 is not compatible with the range of inputtable voltage of the step-up converter 20 (NO in step S115), the ECU 70 is not able to step up the input voltage VL such that the step-up voltage VH becomes higher than or equal to the voltage VB of the battery 10 (not able to execute external charging control). In this case, the ECU 70 stops external charging control (step S120) and proceeds with the process to return.

On the other hand, when the voltage range of the electric power station 80 is compatible with the range of inputtable voltage of the step-up converter 20 (YES in step S115), the ECU 70 is able to output a request to the electric power station 80 to bring the voltage output from the electric power station 80 to the inlet 31 into the range of inputtable voltage of the step-up converter 20 and step up the input voltage VL such that the step-up voltage VH becomes higher than or equal to the voltage VB of the battery 10. In this case, the ECU 70 executes external charging control by controlling the charging relay 30 and the SMR 40 to a closed state (step S121) and proceeds with the process to step S125.

Subsequently, the ECU 70 determines whether the temperature TC is higher than or equal to the threshold temperature THT (step S125). When the temperature TC is higher than or equal to the threshold temperature THT (YES in step S125), the ECU 70 executes the loss reduction process (step S130). The ECU 70, for example, sets the step-up ratio BR to the step-up ratio BR2 (FIG. 4) lower than the step-up ratio BR1.

On the other hand when the temperature TC is lower than the threshold temperature THT (NO in step S125), the ECU 70 executes the output power increasing process (step S140). The ECU 70, for example, sets the step-up ratio BR to the step-up ratio BR1 such that the output electric power OP becomes maximum. The ECU 70 may set the step-up ratio BR by using the map 600 (FIG. 6) in step S130 or in step S140.

After the process of step S130 or step S140, the process proceeds to return. After that, until the SOC of the battery 10 increases to a threshold SOC, a series of processes of FIG. 7 is repeated at predetermined time intervals.

### First Modification of First Embodiment

When there is a plurality of candidates of step-up ratios BR of which the output electric power OP is maximum, the ECU 70 may set the step-up ratio BR to a candidate of which the power loss LS is minimum among the candidates.

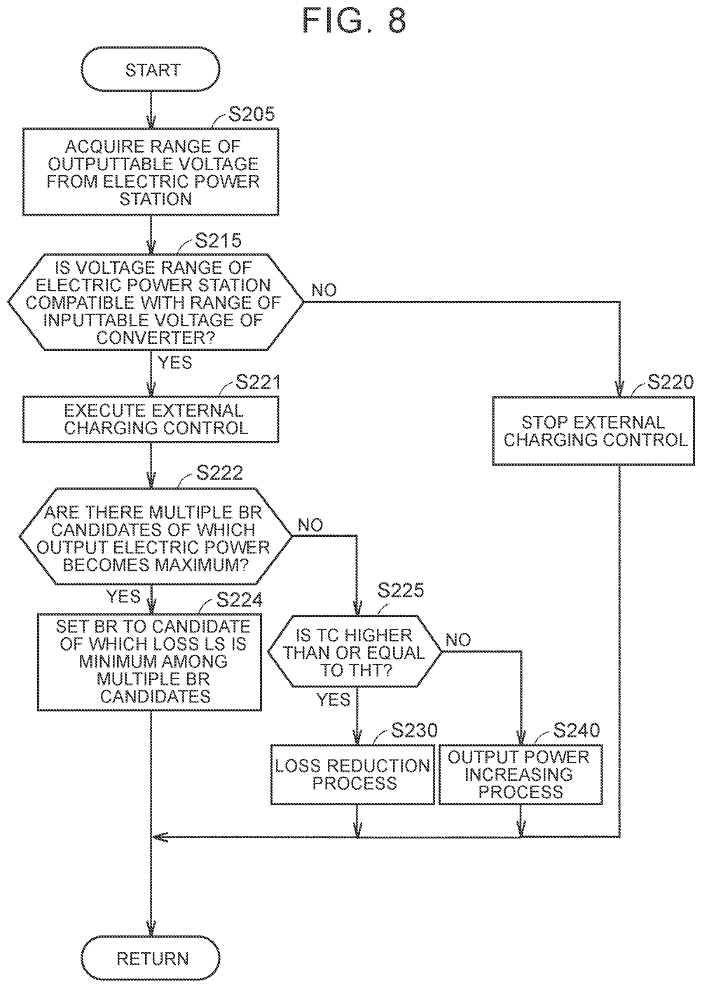

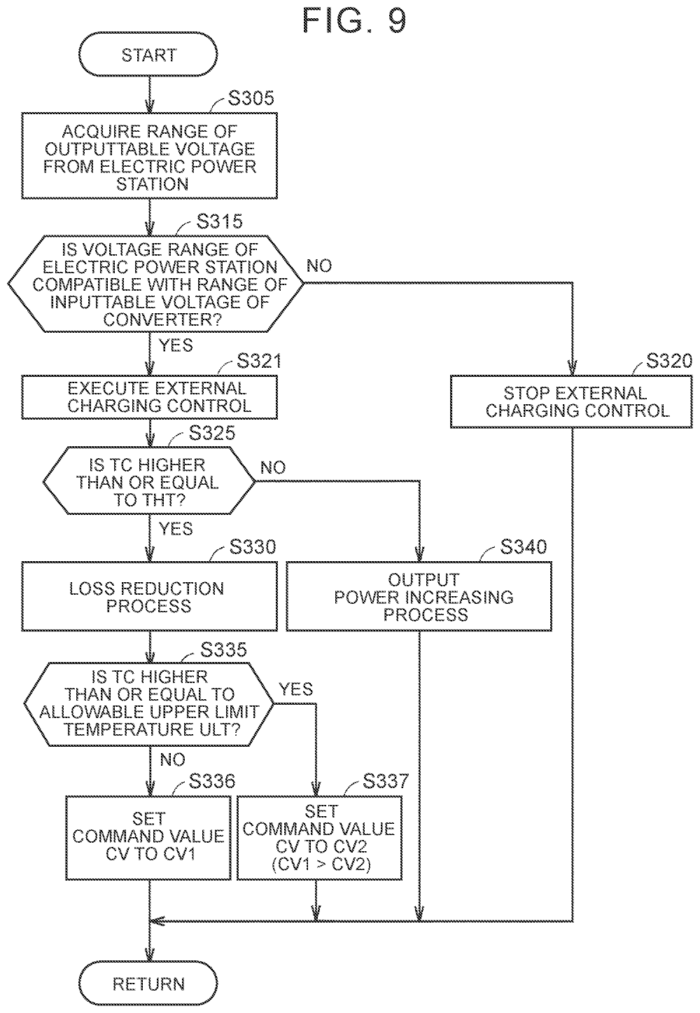

FIG. 8 is a flowchart that shows an example of a process that is executed by the ECU 70 according to the first modification. The process of the flowchart is started when instructions to start supplying electric power from the electric power station 80 to the vehicle 100 are provided in a state where the connector 81 of the electric power station 80 is connected to the inlet 31.

As shown in FIG. 8, the flowchart differs from the flowchart (FIG. 7) of the first embodiment in that the processes of step S222 and step S224 are added. The processes of step S205, step S215, step S220, step S221, step S225, step S230, and step S240 are respectively similar to the processes of step S105, step S115, step S120, step S121, step S125, step S130, and step S140 of the flowchart of the first embodiment.

After the process of step S221, the ECU 70 determines whether there is a plurality of candidates of step-up ratios BR of which the output electric power OP is maximum (step S222). When there is a plurality of candidates of the step-up ratios BR (YES in step 222), the ECU 70 sets the step-up ratio BR to a candidate of which the power loss LS is minimum among the candidates (step S224). On the other hand, when there is not a plurality of candidates of the step-up ratios BR (NO in step S222), the ECU 70 proceeds with the process to step S225.

According to the first modification, when there is a plurality of candidates as described above, it is possible to increase the output electric power OP as much as possible and also possible to reduce the power loss LS as much as possible.

### Second Modification of First Embodiment

When the temperature TC is higher than or equal to the threshold temperature THT (for example, when the temperature TC is higher than or equal to an allowable upper limit temperature higher than the threshold temperature THT) even after the loss reduction process is executed, the ECU 70 may reduce the command value CV (FIG. 1) of current supplied from the electric power station 80 to the inlet 31.

With the above configuration, when the temperature TC does not decrease to below the threshold temperature THT after the loss reduction process, current input to the step-up converter 20 through the inlet 31 from the electric power station 80 (more specifically, the reactor current IL of FIG. 3) reduces. Thus, electric power input to the step-up converter 20 reduces. As a result, it is possible to further reduce the amount of heat generation due to a power loss LS in the step-up converter 20 (for example, the amount of heat generation in the reactor L1). Therefore, it is possible to further effectively suppress an increase in the temperature TC.

FIG. 9 is a flowchart that shows an example of a process that is executed by the ECU 70 according to the second modification. The process of the flowchart is started when instructions to start supplying electric power from the electric power station 80 to the vehicle 100 are provided in a state where the connector 81 of the electric power station 80 is connected to the inlet 31.

As shown in FIG. 9, the flowchart differs from the flowchart (FIG. 7) of the first embodiment in that the processes of step S335, step S336, and step S337 are added. The processes of step S305, step S315, step S320, step S321, step S325, step S330, and step S340 are respectively similar to the processes of step S105, step S115, step S120, step S121, step S125, step S130, and step S140 of the flowchart of the first embodiment.

After the loss reduction process (after step S330), the ECU 70 determines whether the temperature TC is higher than or equal to an allowable upper limit temperature ULT higher than the threshold temperature THT (step S335). The allowable upper limit temperature ULT is appropriately determined in advance by an experiment as an upper limit temperature for protecting the step-up converter 20 from overheating and is stored in the memory 74 of the ECU 70.

When the temperature TC is lower than the allowable upper limit temperature ULT (NO in step S335), the temperature TC falls within the range between the threshold temperature THT and the allowable upper limit temperature ULT. In this case, the ECU 70 sets the command value CV of current supplied from the electric power station 80 to the inlet 31 to a first command value CV1 (step S336). In this example, the first command value CV1 is a value determined in advance as a default value. After the process of step S336, the process proceeds to return.

On the other hand, when the temperature TC is higher than or equal to the allowable upper limit temperature ULT (YES in step S335), the ECU 70 sets the command value CV to a second command value CV2 lower than the first command value CV1 (step S337). In other words, the ECU 70 increases the command value CV from the first command value CV1 that is the default value to the second command value CV2. After the process of step S337, the process proceeds to return.

In the above example, the ECU 70 determines whether to reduce the command value CV in accordance with whether the temperature TC is higher than or equal to the allowable upper limit temperature ULT after the loss reduction process. In contrast, the ECU 70 may determine whether to reduce the command value CV in accordance with whether the duration of a state where the temperature TC is higher than or equal to the threshold temperature THT is longer than or equal to a threshold time after the loss reduction process. The threshold time is appropriately determined in advance by an experiment as a time for protecting the step-up converter 20 from overheating.

### Third Modification of First Embodiment

In the first embodiment, the ECU 70 executes the loss reduction process when the temperature TC is higher than or equal to the threshold temperature THT, while the ECU 70 executes the output power increasing process when the temperature TC is lower than the threshold temperature THT. In contrast, even when the temperature TC is lower than the threshold temperature THT, the ECU 70 may set the step-up ratio BR by giving a priority to a reduction of the power loss LS over an increase of the output electric power OP.

In this third modification, a user operation is performed with the HMI device 90 of the vehicle 100 to equalize the step-up ratio BR in the case where the temperature TC is low with the step-up ratio BR in the case where the temperature TC is high and the loss reduction process is executed. For example, the step-up converter 20 is configured to be able to switch between a plurality of operating modes, and the operating mode of the step-up converter 20 is set by a user to a loss reduction mode among the plurality of operating modes.

The loss reduction mode is a mode in which, even when the temperature TC is lower than the threshold temperature THT, the step-up ratio BR is not set to the step-up ratio BR (for example, the step-up ratio BR1 of FIG. 4) in the case where the output power increasing process is executed and is set to the step-up ratio BR (for example, the step-up ratio BR2) in the case where the loss reduction process is executed.

When the loss reduction mode is set in this way, it is possible to reduce the power loss LS even when the temperature TC is lower than the threshold temperature THT. In addition, a user's intention is reflected in the amount of power loss LS in the step-up converter 20. As a result, it is possible to improve the convenience of a user.

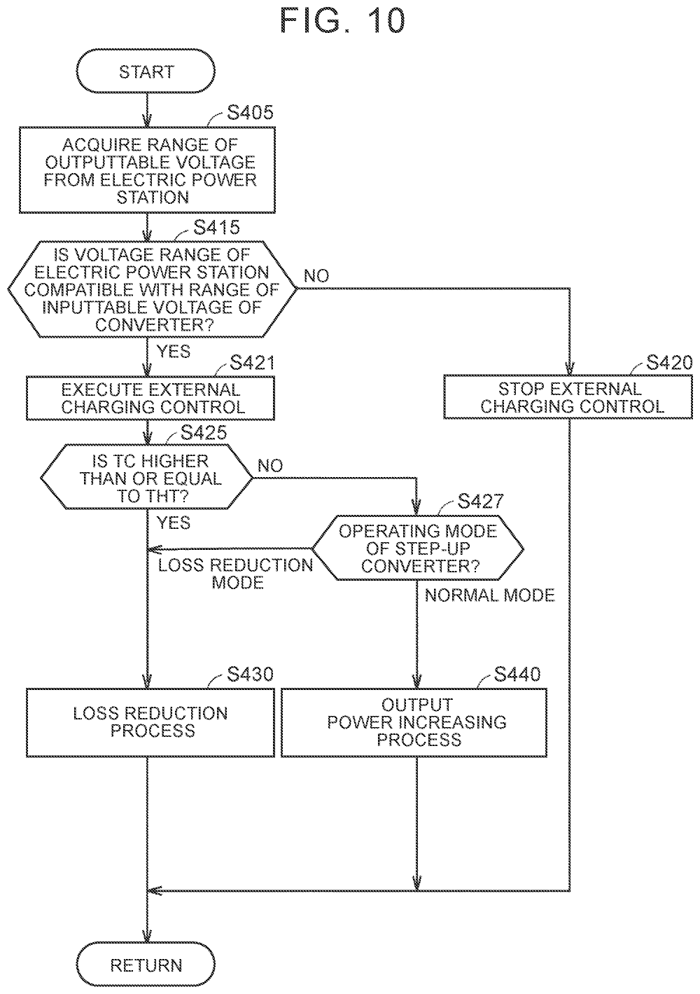

FIG. 10 is a flowchart that shows an example of a process that is executed by the ECU 70 according to the third modification. The process of the flowchart is started when instructions to start supplying electric power from the electric power station 80 to the vehicle 100 are provided in a state where the connector 81 of the electric power station 80 is connected to the inlet 31.

As shown in FIG. 10, the flowchart differs from the flowchart (FIG. 7) of the first embodiment in that the process of step S427 is added. The processes of step S405, step S415, step S420, step S421, step S425, step S430, and step S440 are respectively similar to the processes of step S105, step S115, step S120, step S121, step S125, step S130, and step S140 of the flowchart of the first embodiment.

In this example, before a series of processes of step S405, step S415, step S420, step S421, step S425, step S427, step S430, and step S440 is started, the operating mode of the step-up converter 20 is set in advance by a user to any one of a loss reduction mode and a normal mode. The normal mode is a mode in which the ECU 70 executes the output power increasing process when the temperature TC is higher than or equal to the threshold temperature THT.

When the temperature TC is lower than the threshold temperature THT (NO in step S425), the ECU 70 switches the process in accordance with the operating mode of the step-up converter 20 (step S427). When the operating mode is set to the loss reduction mode, the ECU 70 proceeds with the process to step S430 and sets the step-up ratio BR to, for example, the step-up ratio BR2 (FIG. 4). On the other hand, when the operating mode is set to the normal mode, the ECU 70 executes the output power increasing process by setting the step-up ratio BR to, for example, the step-up ratio BR1 (FIG. 4) (step S440).

### Fourth Modification of First Embodiment

In the above description, the ECU 70 sets the step-up ratio in accordance with the voltage output from the electric power station 80 to the inlet 31 and the voltage VB of the battery 10. In contrast, the ECU 70 may set the step-up ratio in accordance with, for example, only the voltage VB. In this case, the ECU 70 sets the step-up ratio in accordance with the voltage VB by using, for example, the relationship between the voltage VB and the step-up ratio.

### Second Embodiment

In a second embodiment, the temperature TC1 of the diode D1 of the upper arm circuit CU1 or the temperature TC2 of the switching element Q2 of the lower arm circuit CL2 is used as the temperature of the step-up converter 20. The ECU 70 sets the step-up ratio BR in accordance with the temperature TC1 or the temperature TC2. The diode D1 may be regarded as an example of the first element of the disclosure. The switching element Q2 may be regarded as an example of the second element of the disclosure. The configuration of the vehicle 100 in the second embodiment is basically similar to the configuration of the vehicle 100 in the first embodiment (FIG. 1 to FIG. 3). Hereinafter, a method of setting the step-up ratio BR in the second embodiment will be described in detail.

As shown in FIG. 3 again, the ECU 70 sets the step-up ratio BR in accordance with the temperature TC1 of the diode D1 of the upper arm circuit CU1 as the temperature of the step-up converter 20. Specifically, the ECU 70 (processor 72) increases the step-up ratio BR (duty ratio DU) when the temperature TC1 exceeds a first reference temperature. The first reference temperature is appropriately set in advance by an experiment, and the diode D1 is protected from overheating when the temperature TC1 is lower than the first reference temperature.

As the step-up ratio BR is increased, current flowing through the lower arm circuit CL2 (current that circulates through a circuit made up of the capacitor C1, the reactor L1, and the lower arm circuit CL2) increases. As a result, current flowing through the upper arm circuit CU1 (particularly, the diode D1) reduces. When the step-up ratio BR is increased as described above, current flowing through the diode D1 of the upper arm circuit CU1 reduces. Thus, the amount of heat generation due to a power loss in the diode D1 reduces. As a result, it is possible to protect the diode D1 from overheating.

Similarly, the ECU 70 may set the step-up ratio BR in accordance with the temperature TC2 of the switching element Q2 of the lower arm circuit CL2 as the temperature of the step-up converter 20. Specifically, the ECU 70 (processor 72) may reduce the step-up ratio BR (duty ratio DU) when the temperature TC2 exceeds a second reference temperature. The second reference temperature is appropriately set in advance by an experiment, and the switching element Q2 is protected from overheating when the temperature TC2 is lower than the second reference temperature.

As the step-up ratio BR is reduced, current flowing through the upper arm circuit CU1 (current supplied to the battery 10 through the upper arm circuit CU1 and the positive electrode line PL) increases. As a result, current flowing through the lower arm circuit CL2 (particularly, the switching element Q2) reduces. When the step-up ratio BR is reduced as described above, current flowing through the switching element Q2 of the lower arm circuit CL2 reduces. Thus, the amount of heat generation due to a power loss in the switching element Q2 reduces. As a result, it is possible to protect the switching element Q2 from overheating.

### Other Modifications

As shown in FIG. 2 again, an AC-DC converter may be provided between the inlet 31 and step-up converter 20 of the vehicle 100. Thus, even when the electric power station 80 is configured to supply alternating-current power to the vehicle 100, alternating-current power from the electric power station 80 is converted to direct-current power by the AC-DC converter and then input to the step-up converter 20. The ECU 70, as in the case of the first embodiment, the first to fourth modifications, and the second embodiment, sets the step-up ratio BR in accordance with the temperature TC of the step-up converter 20 (executes, for example, the loss reduction process or the output power increasing process).

In the above description, a step-up copper circuit (FIG. 3) is used as an example of the step-up converter 20. Alternatively, a step-up device of another type, such as a charge-pump type, may be used.

What is claimed is:

1. A charge controller that controls external charging for charging an electrical storage device of a vehicle with electric power from a power installation outside the vehicle,
the vehicle including;
a power receiving unit configured to receive electric power from the power installation, and
a step-up device provided between the power receiving unit and the electrical storage device, the step-up device being configured to
step up an input voltage that is a voltage of electric power input to the step-up device through the power receiving unit from the power installation and output a step-up voltage that is the stepped-up voltage to the electrical storage device, and
charge the electrical storage device by supplying output electric power that is electric power at the step-up voltage to the electrical storage device,
the charge controller comprising:
an electronic control unit including a memory, the electronic control unit being configured to;
execute drive control over the step-up device, and
set a step-up ratio that is a ratio between the input voltage and the step-up voltage in accordance with a temperature of the step-up device.

2. The charge controller according to claim 1, wherein
the electronic control unit is configured to execute a loss reduction process of setting the step-up ratio such that a power loss in the step-up device is reduced when the temperature of the step-up device is high as compared to when the temperature of the step-up device is low.

3. The charge controller according to claim 2, wherein
in the loss reduction process, the electronic control unit is configured to set the step-up ratio such that the power loss is reduced when the temperature of the step-up device is higher than or equal to a threshold temperature as compared to when the temperature of the step-up device is lower than the threshold temperature.

4. The charge controller according to claim 3, wherein
the electronic control unit is configured to
send, to the power installation, a command value of current supplied from the power installation to the power receiving unit, and
reduce the command value when the temperature of the step-up device is higher than or equal to the threshold temperature after executing the loss reduction process.

5. The charge controller according to claim 2, wherein
in the loss reduction process, the electronic control unit is configured to set the step-up ratio such that the power loss is reduced as the temperature of the step-up device increases.

6. The charge controller according to claim 2, wherein
the electronic control unit is configured to execute an output power increasing process of setting the step-up ratio such that the output electric power increases when the temperature of the step-up device is low as compared to when the temperature of the step-up device is high.

7. The charge controller according to claim 6, wherein
in the output power increasing process, the electronic control unit is configured to maximize the output electric power within a range of electric power that the step-up device is allowed to output to the electrical storage device.

8. The charge controller according to claim 6, wherein
when a user operation has been performed to equalize the step-up ratio in a case where the temperature of the step-up device is low with the step-up ratio in a case where the temperature of the step-up device is high and the loss reduction process is executed, the electronic control unit is configured to set the step-up ratio in accordance with a result of the user operation without executing the output power increasing process.

9. The charge controller according to claim 1, wherein
the step-up device includes a first element connected to a positive electrode of the electrical storage device,
the electronic control unit is configured to increase the step-up ratio when a temperature of the first element, that is, the temperature of the step-up device, exceeds a first reference temperature.

10. The charge controller according to claim 1, wherein:
the step-up device includes a second element connected to a negative electrode of the electrical storage device,
the electronic control unit is configured to increase the step-up ratio when a temperature of the second element, that is, the temperature of the step-up device, exceeds a second reference temperature.

11. A vehicle comprising the charge controller according to claim 1.
